(19) United States
(12) Patent Application Publication
(10) Pub. No.: US 2024/0291420 A1
(43) Pub. Date: Aug. 29, 2024

(54) SOLAR PANEL MOUNTING SYSTEM

(71) Applicant: Unirac, Inc., Albuquerque, NM (US)

(72) Inventors: Jeffrey Ballard, Albuquerque, NM (US); Gary Norman, Louisville, CO (US); Tarun Kumar Polanky, Hyderabad (IN)

(21) Appl. No.: 18/587,386

(22) Filed: Feb. 26, 2024

Related U.S. Application Data
(60) Provisional application No. 63/448,480, filed on Feb. 27, 2023.

(51) Int. Cl. H02S 20/23

(52) U.S. Cl. CPC H02S 20/23

(57) ABSTRACT

A mounting system for a solar panel module includes a first mount for supporting a solar panel module a first distance above a surface and a second mount for supporting the solar panel module a second distance above the surface. The first mount includes a receptacle to receive a first side of the solar panel module and one or more prongs to engage the solar panel module along the first side. The second mount includes a receptacle to receive a second side of the solar panel module, opposite the first side of the solar panel module, and one or more prongs to engage the solar panel module along the second side.

### CROSS-REFERENCE TO RELATED APPLICATIONS

This application claims priority to U.S. Provisional Application No. 63/448,480, filed Feb. 27, 2023, entitled “Solar Panel Roof Mounting Equipment,” the entirety of which is herein incorporated by reference.

### BACKGROUND

The solar industry is growing world-wide and, as a result, more-efficient structures are desirable for mounting photovoltaic modules or solar panel modules to a structure, such as a roof of a home or other building. While different structures are known, there is a desire to reduce their complexity and/or efficiency. Therefore, there is a need for improved equipment to mount solar panel modules.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features. The components, devices, and/or apparatuses depicted in the accompanying figures are not to scale and components within the figures may be depicted not to scale with each other.

FIG. 1 illustrates an example mounting system including an example first mount and an example second mount usable with a solar panel module, according to an embodiment of the present disclosure.

FIG. 2 illustrates an example use of the first mount and the second mount with the solar panel module of FIG. 1, according to an embodiment of the present disclosure.

FIG. 3A illustrates an isometric view of the first mount of FIG. 1, according to an embodiment of the present disclosure.

FIG. 3B illustrates another isometric view of the first mount of FIG. 1, according to an embodiment of the present disclosure.

FIG. 3C illustrates a front view of the first mount of FIG. 1, according to an embodiment of the present disclosure.

FIG. 3D illustrates a back view of the first mount of FIG. 1, according to an embodiment of the present disclosure.

FIG. 3E illustrates a top view of the first mount of FIG. 1, according to an embodiment of the present disclosure.

FIG. 3F illustrates a bottom view of the first mount of FIG. 1, according to an embodiment of the present disclosure.

FIG. 3G illustrates a left side view of the first mount of FIG. 1, according to an embodiment of the present disclosure.

FIG. 3H illustrates a right side view of the first mount of FIG. 1, according to an embodiment of the present disclosure.

FIG. 4A illustrates an exploded isometric view of the second mount of FIG. 1, according to an embodiment of the present disclosure.

FIG. 4B illustrates another exploded isometric view of the second mount of FIG. 1, according to an embodiment of the present disclosure.

FIG. 5A illustrates a left side view of a lower member of the second mount of FIGS. 4A and 4B, according to an embodiment of the present disclosure.

FIG. 5B illustrates a right side view of the lower member of the second mount of FIGS. 4A and 4B, according to an embodiment of the present disclosure.

FIG. 5C illustrates a front view of the lower member of the second mount of FIGS. 4A and 4B, according to an embodiment of the present disclosure.

FIG. 5D illustrates a back view of the lower member of the second mount of FIGS. 4A and 4B, according to an embodiment of the present disclosure.

FIG. 5E illustrates a top view of the lower member of the second mount of FIGS. 4A and 4B, according to an embodiment of the present disclosure.

FIG. 5F illustrates a bottom view of the lower member of the second mount of FIGS. 4A and 4B, according to an embodiment of the present disclosure.

FIG. 6A illustrates a top view of an upper member of the second mount of FIGS. 4A and 4B, according to an embodiment of the present disclosure.

FIG. 6B illustrates a bottom view of the upper member of the second mount of FIGS. 4A and 4B, according to an embodiment of the present disclosure.

FIG. 6C illustrates a left side view of the upper member of the second mount of FIGS. 4A and 4B, according to an embodiment of the present disclosure.

FIG. 6D illustrates a right side view of the upper member of the second mount of FIGS. 4A and 4B, according to an embodiment of the present disclosure.

FIG. 6E illustrates a front view of the upper member of the second mount of FIGS. 4A and 4B, according to an embodiment of the present disclosure.

FIG. 6F illustrates a back view of the upper member of the second mount of FIGS. 4A and 4B, according to an embodiment of the present disclosure.

FIG. 7A illustrates the first mount of FIG. 1 coupled to an example first base, according to an embodiment of the present disclosure.

FIG. 7B illustrates a cross-sectional, partial view, taken along line A-A of FIG. 7A, according to an embodiment of the present disclosure.

FIG. 8A illustrates the second mount of FIG. 1 coupled to an example second base, according to an embodiment of the present disclosure.

FIG. 8B illustrates a cross-sectional, partial view, taken along line B-B of FIG. 8A, according to an embodiment of the present disclosure.

FIG. 9A illustrates the first mount of FIG. 1 coupled to a solar panel module, according to an embodiment of the present disclosure.

FIG. 9B illustrates a cross-sectional, part view, taken along line C-C of FIG. 9A, according to an embodiment of the present disclosure.

FIG. 10A illustrates the second mount of FIG. 1 coupled to a solar panel module, according to an embodiment of the present disclosure.

FIG. 10B illustrates the second mount of FIG. 1 coupled to a solar panel module and a wind deflector, according to an embodiment of the present disclosure.

FIG. 10C illustrates the second mount of FIG. 1 coupled to a solar panel module, a wind deflector, and a ballast tray, according to an embodiment of the present disclosure.

### DETAILED DESCRIPTION

This application is directed, at least in part, to a mounting system for mounting solar panel modules, according to an embodiment of the present disclosure. In an embodiment, the mounting system may include at least a first mount and a second mount that couple to the solar panel module. In an embodiment, the first mount may couple to a first side of the solar panel module, while the second mount may couple to a second side of the solar panel module, opposite the first side. The first mount and the second mount may support a length of the solar panel module between other mounts, brackets, and so forth. For example, a rail system may be used to couple the solar panel module to a surface, such as a roof. In an embodiment, the rail system may include brackets disposed at predetermined locations along the rail, and the brackets may couple to the solar panel module. The first mount and the second mount may be disposed at a location between the brackets, for example, within a middle of the solar panel module. In doing so, the first mount and the second mount may support a weight of the solar panel module between the brackets to prevent damage to the solar panel module. In an embodiment, the first mount and/or the second mount may transfer at least a portion of a load of the solar panel module to the surface.

In an embodiment, the first mount may include a top that couples to the solar panel module, and a bottom that couples to a surface (e.g., roof). For example, the solar panel module may be disposed above, or spaced apart from, the surface and the first mount may support the solar panel module. In an embodiment, the first mount may rest on the surface or may couple to the surface (e.g., using fasteners). In an embodiment, the bottom of the first mount may include padding (e.g., rubber, silicone, etc.) to prevent damage to the surface. A body of the first mount extends between the top and the bottom for disposing the solar panel module above the surface.

In an embodiment, the first mount may include a receptacle that receives at least a portion of the solar panel module. The solar panel module, for example, may include a frame that engages within the receptacle to secure the first mount to the solar panel module. In an embodiment, the receptacle of the first mount may be located at the top. In an embodiment, the receptacle may include engagement mechanisms, such as prongs, tabs, and the like that engage with the solar panel module, such as the frame. In doing so, the first mount may be secured to the solar panel module. However, upon application of a predetermined amount of force, the solar panel module (or a portion thereof) may be removably coupled from the first mount.

In an embodiment, the second mount may include a lower member (e.g., portion, section, segment, etc.) and an upper member (e.g., portion, section, segment, etc.) that couple together. The lower member may include a top that couples to the upper member, and a bottom that couples to the surface (e.g., roof). In an embodiment, the lower member of the second mount, such as the bottom, may rest on the surface or may couple to the surface (e.g., using fasteners). In an embodiment, the bottom of the lower member of the second mount may include padding (e.g., rubber, silicone, etc.) to prevent damage to the surface. A body of the lower member of the second mount extends between the top and the bottom for disposing the solar panel module above the surface.

Additionally, the body of the lower member of the second mount may include curvatures, shapes, indents, and features that route around, through, and/or alongside features of the solar panel module. For example, sections of the body of the lower member may curve alongside, over, around, etc. ballast trays that are used to secure the solar panel module to the surface. In an embodiment, the ballast trays couple to the rail system on which the brackets are disposed. Additionally, sections of the body of the lower member may curve alongside or around wind deflectors that couple to the solar panel module and/or the second mount. In an embodiment, the members of the second mount (i.e., the lower member and the upper member) may enable the second mount to be disposed around ballast trays and/or wind deflectors coupled to the solar panel module.

The upper member of the second mount may couple to the lower member of the second mount. In an embodiment, the upper member may couple to the lower member of the second mount proximate to the top of the lower member. The upper member may be secured to the lower member via fastener(s). In an embodiment, the lower member includes a threaded passage into which the fastener is received, and the upper member may include a slot that at least partially receives a fastener. As the fastener is tightened, the upper member may become compressed between the lower member and the fastener, thereby securing the upper member to the lower member. The slot of the upper member may allow the upper member to be disposed various distances above the lower member, for example, to adjust a height of the solar panel module or to accommodate a height of the solar panel module above the surface.

The upper member may include a receptacle that receives the solar panel module. For example, the frame of the solar panel module may engage with the solar panel at a location at least partially within the receptacle of the upper member. In an embodiment, the receptacle may be disposed on a top of the upper member. The receptacle may include engagement mechanisms, such as prongs, tabs, and the like that engage with the solar panel module. In doing so, the second mount may be secured to the solar panel module. However, upon application of a predetermined amount of force, the solar panel module (or a portion thereof) may be removably coupled from the second mount. In an embodiment, an opening of the receptable of the upper member may be opposing to an opening of the receptacle of the lower member.

Although the second mount is described as having multiple members (e.g., two), in an embodiment, the second mount may include more than or less than two members. For example, the second mount may include three members or four members that couple together to support the solar panel module. Alternatively, in an embodiment not shown, the second mount may be formed from a single member. For example, the second mount may be used in conjunction with solar panel modules that lack wind deflectors and/or ballast trays. In such embodiments, the second mount may not need to include multiple members that couple together to route around or otherwise accommodate the ballast trays and/or the wind deflectors. Here, in an embodiment, the second mount may be similar to the first mount.

In an embodiment, the first mount may extend a first height above the surface and the second mount may extend a second height above the surface. The second height may be greater than the first height. The first side of the solar panel module may be disposed a first distance above the surface, while the second side of the solar panel module may be disposed a second distance above the surface, where the second distance may be greater than the first distance. Accordingly, in an embodiment, the solar panel module may be angled, tilted, etc. relative to the surface, in connection with the orientation of north to south.

As introduced above, the first mount and the second mount may be used in combination with other mounts, brackets, and/or systems that secure the solar panel module to the surface. In an embodiment, the first mount and the second mount may be interposed between other brackets that secure the solar panel module to the surface in order to support a weight of the solar panel modules between the brackets. For example, a first bracket may couple to the solar panel module proximate to a first corner (e.g., along a first side) of the solar panel module, a second bracket may couple to the solar panel module proximate to a second corner (e.g., along the first side) of the solar panel module, a third bracket may couple to the solar panel module proximate to a third corner (e.g., along a second side) of the solar panel module, and a fourth bracket may couple to the solar panel module proximate to a fourth corner (e.g., along the second side) of the solar panel module. The first mount may be disposed along the first side, between the first bracket and the second bracket, for example, to support a weight of the solar panel module between the first bracket and the second bracket. The second mount may be disposed along the second side, between the third bracket and the fourth bracket, for example, to support a weight of the solar panel module between the third bracket and the fourth bracket.

In an embodiment, the first mount may be considered a “south mount” and the second mount may be considered a “north mount,” where north and south are understood in the industry to represent an orientation along a solar panel module to position the solar panel module for ideal sunlight. For example, the first mount may be disposed on a south side of the solar panel module and the second mount may be disposed on a north side of the solar panel module. However, although a particular orientation is described, other orientations and/or positions of the first mount and second mount are envisioned.

In an embodiment, the first mount and/or the second mount are formed via bending, stamping, and/or extrusion processes. The first mount and/or the second mount may be formed from metals, ceramics, composites, plastics, and so forth. Moreover, any number of the first mounts and/or the second mounts may be used to support the solar panel module. For example, depending upon dimensions of the solar panel module (e.g., length), more than one first mount and/or more than one second mount may be used to support a weight of the solar panel module. Additionally, and/or alternatively, the number of mounts may be based on local environmental conditions. In other embodiments, the first mount and/or the second mount may be substituted with alternative mounting devices (or potentially not be used at all), e.g., where a downforce support may not be needed.

The present disclosure provides an overall understanding of the principles of the structure, function, device, and system disclosed herein. One or more examples of the present disclosure are illustrated in the accompanying drawings. Those of ordinary skill in the art will understand that the devices and/or the systems specifically described herein and illustrated in the accompanying drawings are non-limiting embodiments. The features illustrated or described in connection with one embodiment may be combined with the features of other embodiments. Such modifications and variations are intended to be included within the scope of the appended claims.

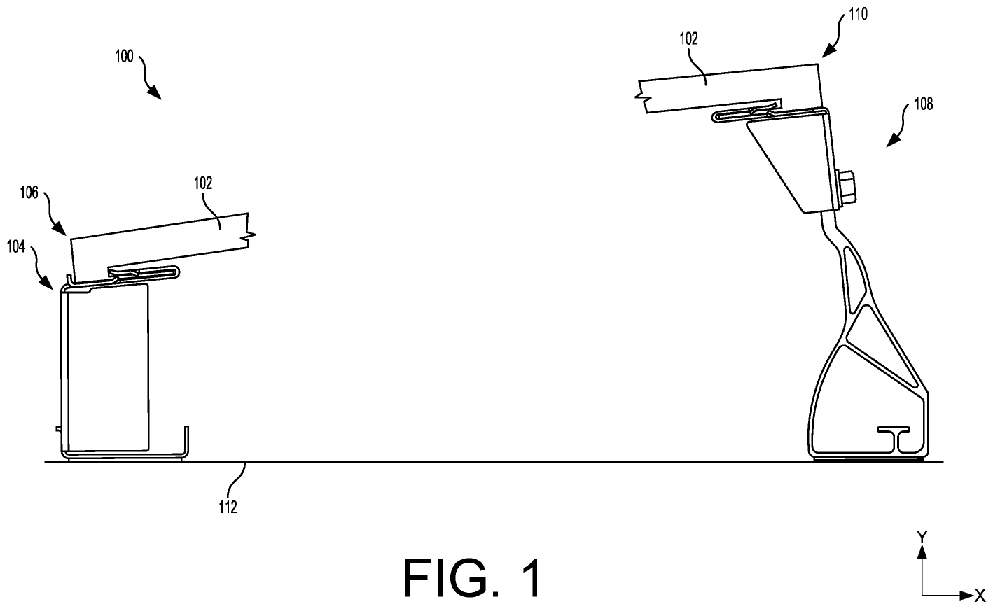

FIG. 1 illustrates an example system 100 (e.g., mounting system, mounting assembly, etc.) used to support a solar panel module 102, according to embodiments of the present disclosure. In an embodiment, the system 100 may include a first mount 104 (e.g., bracket, brace, stand, etc.) (also known as a “south” mount). The first mount 104 may be used to couple to or be disposed along a first side 106 of the solar panel module 102. Further, the system 100 may include a second mount 108 (e.g., bracket, brace, stand, etc.) (also known as a “north” mount) to couple to or be disposed along a second side 110 of the solar panel module 102. A dimension, for example, a width of the solar panel module 102 may span between the first side 106 and the second side 110 (e.g., in the X-direction).

As will be explained herein, the first mount 104 and the second mount 108 may include respective receptacles into which the solar panel module 102 is received. For example, the receptacles may secure the solar panel module 102 to the first mount 104 and the second mount 108, respectively. As shown, the first mount 104 and the second mount 108 may be disposed on a surface 112 (e.g., roof). In doing so, the first mount 104 and the second mount 108 may assist in supporting a weight of the solar panel module 102. For example, the first mount 104 and the second mount 108 may support at least a portion of the weight of the solar panel module 102 on the surface 112. In an embodiment, the first mount 104 and/or the second mount 108 may be disposed on the surface 112 (e.g., via fastener(s)). The surface 112 may be flat (e.g., level ground, or flat roof) or angled (e.g., sloped ground, sloped roof).

In an embodiment, the first mount 104 and the second mount 108 may be located between opposing ends, sides, etc. of the solar panel module 102 (e.g., in the Z-direction). For example, the first mount 104 may be disposed along the first side 106, between a first end and a second end of the solar panel module 102 (e.g., in the Z-direction). The second mount 108 may be disposed along the second side 110, between the first end and the second end of the solar panel module 102 (e.g., in the Z-direction). In an embodiment, additional brackets, for example, may be secured to the solar panel module 102 at the ends, or proximate thereto, to couple the solar panel module 102 to the surface 112 (e.g., via a system of brackets and/or rails). The first mount 104 and the second mount 108 may support a weight of the solar panel module 102, between the brackets to prevent the solar panel module 102 deflecting (e.g., in the Y-direction).

In an embodiment, the first mount 104 may include a height (e.g., in the Y-direction) that is less than a height (e.g., in the Y-direction) of the second mount 108. The heights of the first mount 104 and the second mount 108, respectively, may dispose the solar panel module 102 at a proper angles to receive sunlight. For example, the first mount 104 and the second mount 108 may dispose (e.g., tilt) the solar panel module 102 between five and forty degrees relative to the surface 112, but the disclosed embodiments are not limited to any range of tilt. In an embodiment, the first mount 104 and the second mount 108 may be adjusted, manufactured, etc. to dispose the solar panel module 102 at predetermined angles.

In FIG. 1, the solar panel module 102 is shown as fragmented and/or disposed on different planes (e.g., X-Z plane). However, when the first mount 104 and the second mount 108 are spaced apart appropriately from one another (e.g., in the X-direction), the solar panel module 102 may be disposed on the same plane. In an embodiment, the first mount 104 may be disposed on a “low” side of the solar panel module 102, while the second mount 108 may be disposed on a “high” side of the solar panel module 102. In doing so, the solar panel module 102 may be angled, and the solar panel module 102 along the second side 110 may be disposed a greater distance above the surface 112 as compared to the first side 106.

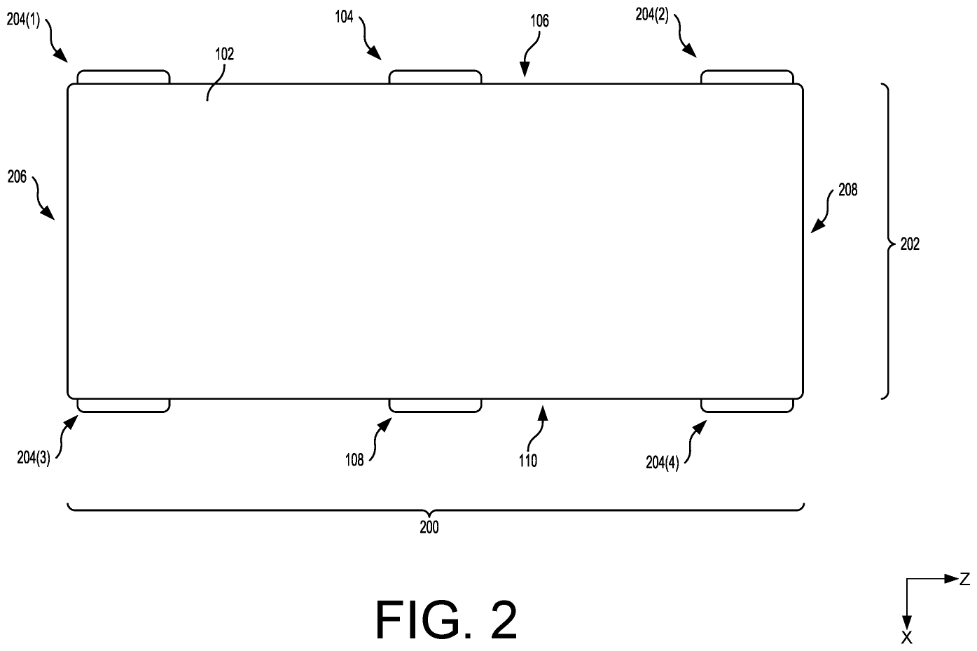

FIG. 2 illustrates an example use of the first mount 104 and the second mount 108, according to embodiments of the present disclosure. The solar panel module 102 may have a length 200 (e.g., in the Z-direction) and a width 202 (e.g., in the X-direction). In an embodiment, the solar panel module 102 may be secured to the surface 112 via one or more brackets 204, such as a first bracket 204(1), a second bracket 204(2), a third bracket 204(3), and a fourth bracket 204(4). In an embodiment, the brackets 204 may be coupled to the surface 112 via fasteners, other frames, mounts, and so forth. Additionally, in an embodiment, the brackets 204 may be disposed along rail(s) that extend across the surface 112, and to which other brackets couple for securing other solar panel modules to the surface 112. As such, the surface 112 may include more than one solar panel module 102, such as a system of solar panel modules.

The first bracket 204(1) may secure to the solar panel module 102 along the first side 106, and proximate to a first end 206 of the solar panel module 102. The second bracket 204(2) may secure to the solar panel module 102 along the first side 106, and proximate to a second end 208 of the solar panel module 102, spaced apart from the first end 206. The third bracket 204(3) may secure to the solar panel module 102 along the second side 110, and proximate to the first end 206 of the solar panel module 102. The fourth bracket 204(4) may secure to the solar panel module 102 along the second side 110, and proximate to the second end 208 of the solar panel module 102.

In an embodiment, the first mount 104 may couple to the solar panel module 102 at a location between the first bracket 204(1) and the second bracket 204(2). The first mount 104 may support a weight of the solar panel module 102 across the length 200, for example, between the first bracket 204(1) and the second bracket 204(2), to prevent the solar panel module 102 deflecting, buckling, etc. between the first bracket 204(1) and the second bracket 204(2) (e.g., in the Y-direction). The second mount 108 may couple to the solar panel module 102 at a location between the third bracket 204(3) and the fourth bracket 204(4). The second mount 108 may support a weight of the solar panel module 102 across the length 200, for example, between the third bracket 204(3) and the fourth bracket 204(4), to prevent the solar panel module 102 deflecting between the third bracket 204(3) and the fourth bracket 204(4).

In an embodiment, the first mount 104 may be centered between the first bracket 204(1) and the second bracket 204(2), and/or the second mount 108 may be centered between the third bracket 204(3) and the fourth bracket 204(4). Additionally, although one of the first mount 104 and one of the second mount 108 are shown coupled to the solar panel module 102, more than one of the first mount 104 and/or more than one of the second mount 108 may be coupled to the solar panel module 102 along the first side 106 and the second side 110, respectively. For example, depending upon the length 200, the width 202, the weight, etc. of the solar panel module 102, more than one of the first mount 104 and/or more than one of second mount 108 may be used.

The first mount 104 and the second mount 108 may therefore at least partially support a weight of the solar panel module 102. In an embodiment, the first mount 104 and/or the second mount 108 may be installed retroactively. For example, the first mount 104 and the second mount 108 may be installed after solar panel module 102 is secured to the surface 112 via the brackets 204(or other like brackets, mounts, braces, etc.). As will be discussed herein, the geometry of the first mount 104 and the second mount 108 may allow for an avoidance of obstacles present in the brackets 204 and/or the solar panel module 102 (e.g., ballast tray, wind deflector, etc.).

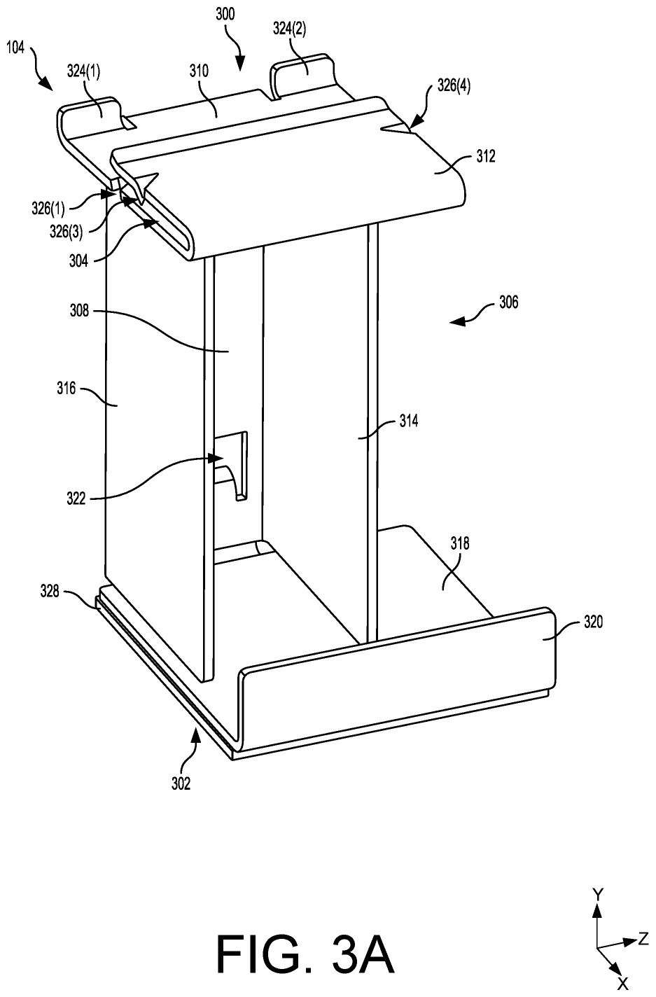

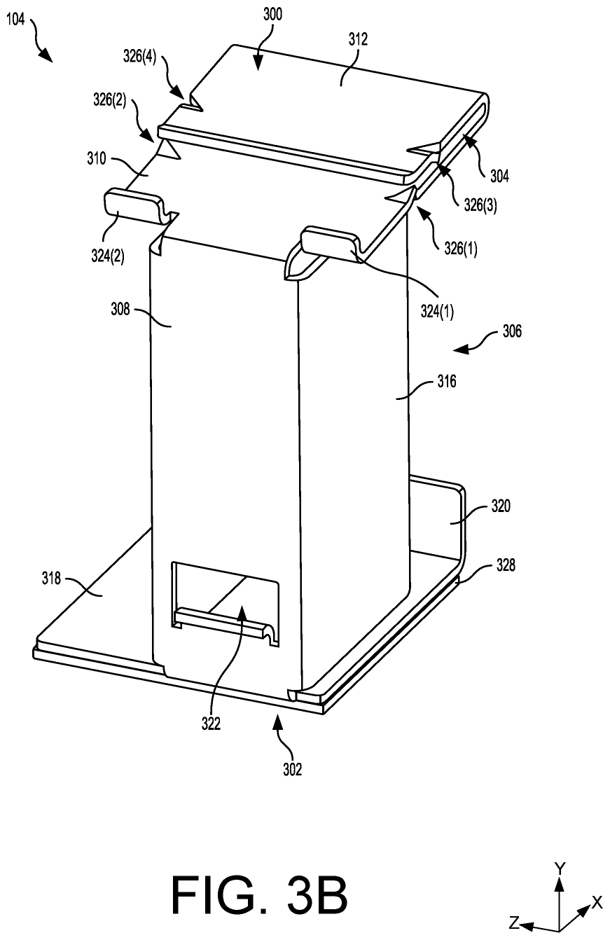

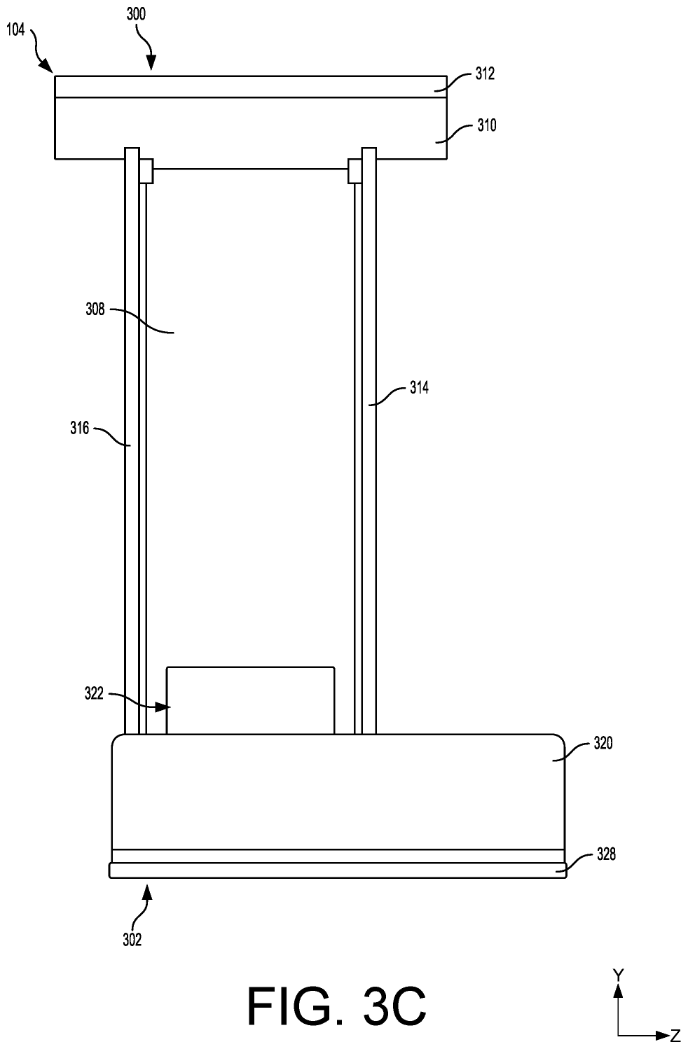

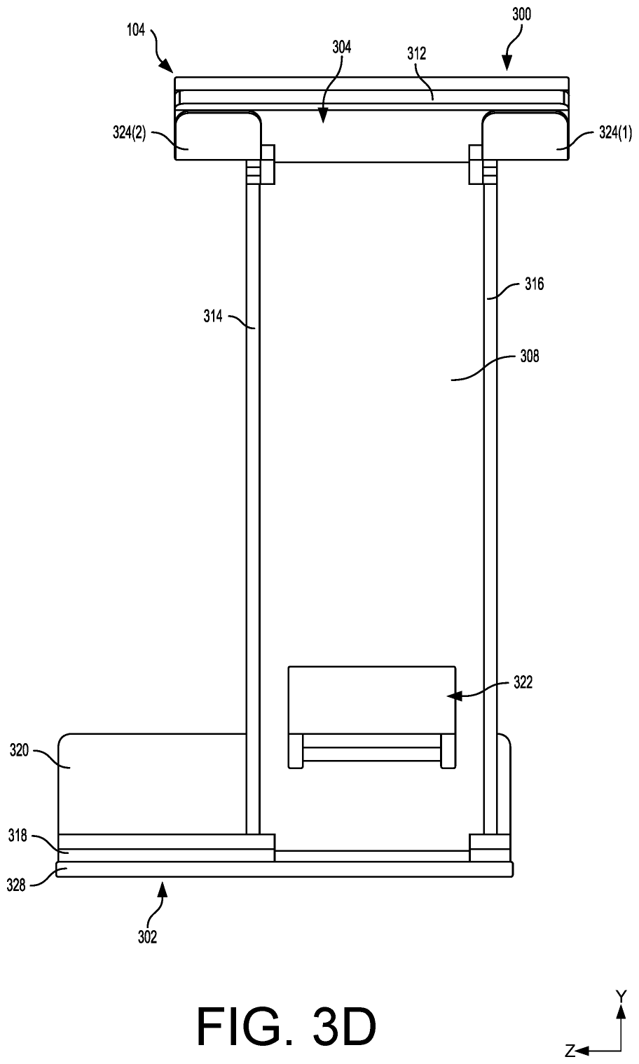

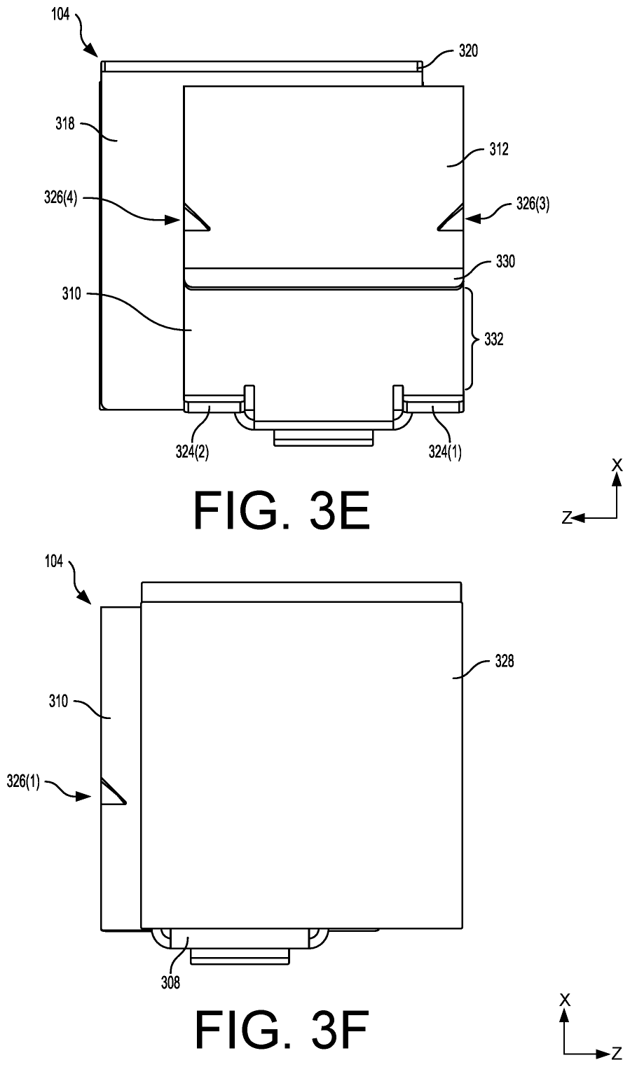

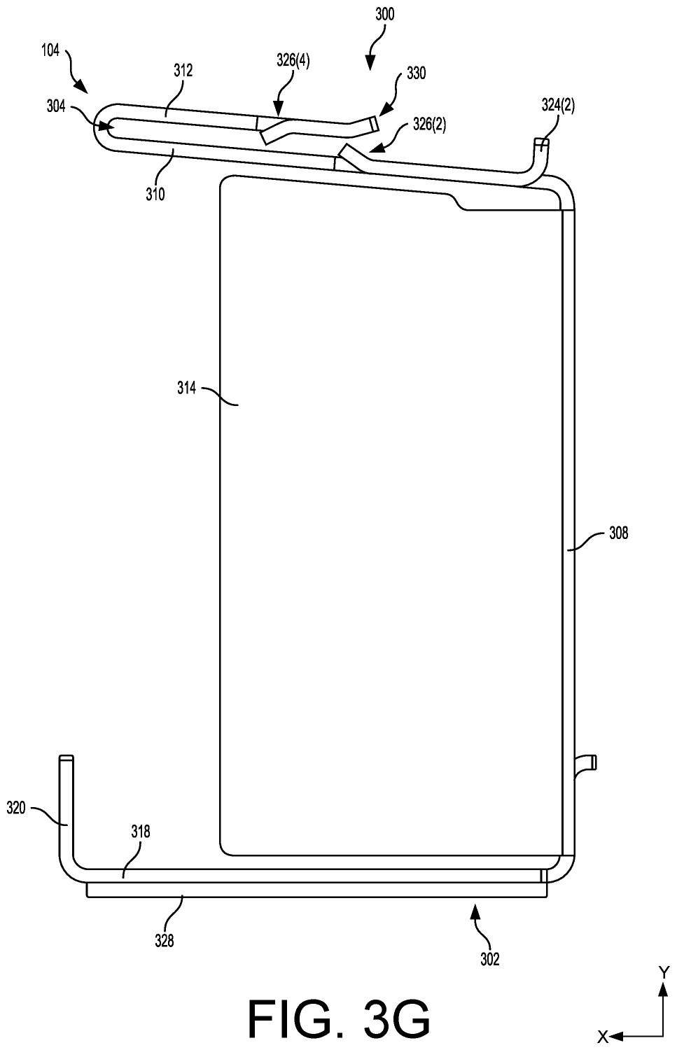

FIGS. 3A-3H illustrate views of the first mount 104, according to embodiments of the present disclosure. The first mount 104 may include a top 300 and a bottom 302 spaced apart from the top 300 (e.g., in Y-direction). The top 300 may include a receptacle 304 that receives at least a portion of the solar panel module 102, such as a portion of a frame of the solar panel module 102, while the bottom 302 may be disposed on the surface 112 for supporting a weight of the solar panel module 102.

The first mount 104 may be made up of a single piece of material that is bent, stamped, etc., so as to be formed as a unitary, continuously formed body shaped by the bending and stamping of a sheet material. In an embodiment, the first mount 104 has a body 306 that may include many members (e.g., first through seventh members), where a first member is a main back plate 308 from which the other members branch. A second member is an upper plate 310 that folds from or is connected to an upper end of the main back plate 308. A third member is a frame catch plate 312 that folds (or returns) back from an end of the upper plate 310. A fourth member is a left flange plate 314 that folds from or is connected to a left side of the main back plate 308. A fifth member is a right flange plate 316 that folds from or is connected to a right side of the main back plate 308, opposite from the left flange plate 314. A sixth member is a lower support plate 318 that folds from or is connected to a lower end of the main back plate 308, opposite the upper end of the main back plate 308. A seventh member is a base catch plate 320 that folds from or is connected to a distal end of the lower support plate 318. As used herein, a “member” may be an metal strip (e.g., plate, planar segment, section, etc.) integrally joined or formed with other strips, for example. Although described as members, the members may represent sections, segments, portions, panels, etc. of the first mount 104.

In an embodiment, the upper plate 310, the left flange plate 314, the right flange plate 316, and/or the lower support plate 318 may be adjoined to or extend from the main back plate 308. In an embodiment, the upper plate 310, the left flange plate 314, the right flange plate 316, and/or the lower support plate 318 may extend transverse to the main back plate 308. Additionally, the base catch plate 320 may extend transverse to the lower support plate 318. In an embodiment, the upper plate 310 extends from the main back plate 308 by a greater distance than the left flange plate 314 and/or the right flange plate 316 (e.g., in the X-direction) for supporting the solar panel module 102.

In an embodiment, the lower support plate 318 (i.e., the bottom 302) of the first mount 104 is planar (e.g., is the X-Z plane). The main back plate 308 and/or the base catch plate 320 may be oriented orthogonal to the lower support plate 318. In an embodiment, the top 300 may be oriented between approximately five to forty degrees relative to the bottom 302. As such, in an embodiment, the upper plate 310 and/or the frame catch plate 312 may not be orthogonal to the main back plate 308, and/or parallel with the lower support plate 318. The angle of the upper plate 310 and the frame catch plate 312 may be associated with an angle at which the solar panel module 102 is disposed on the surface 112. As such, the angle of the upper plate 310 and/or the frame catch plate 312 relative to the surface 112, the lower support plate 318, or the bottom 302 may be disposed at a plurality of angles associated with an angle of the solar panel module 102. The upper plate 310 and the frame catch plate 312 may be bent to form the desired angle at which the solar panel module 102 is disposed. Other angles are envisioned other than those described.

The frame catch plate 312 may be at least partially disposed over the upper plate 310 to define the receptacle 304 (e.g., a space or gap created between the upper plate 310 and the frame catch plate 312, a slotted frame catch, etc.). For example, an interface between the upper plate 310 and the frame catch plate 312 may be bent such that the frame catch plate 312 may be disposed above the upper plate 310. In an embodiment, the frame catch plate 312 may be parallel to the upper plate 310. However, a gap distance may be disposed between the upper plate 310 and the frame catch plate 312 such that the frame of the solar panel module 102 may be insertable within the receptacle 304.

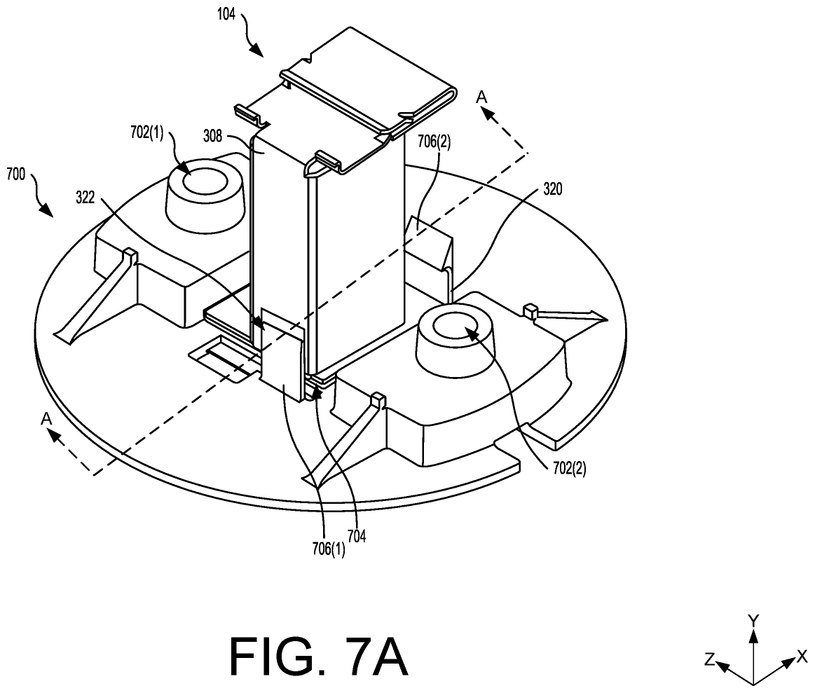

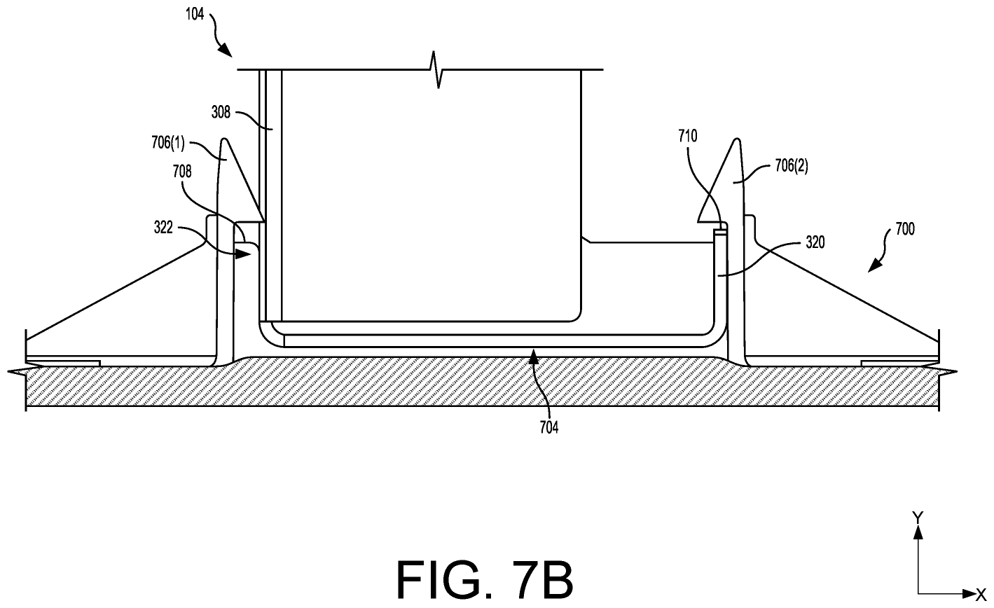

In an embodiment, and as will be discussed herein, the first mount 104 may couple to a base disposed on the surface 112. The first mount 104 may couple to the base via an opening 322 in the main back plate 308 and/or via an engagement with the base via the base catch plate 320. For example, as will be shown and described in FIGS. 7A and 7B, the base may include tab(s) that engage with the first mount 104 at a location within the opening 322 and/or on the base catch plate 320 (e.g., a top surface thereof). The tab(s) may snap over, engage, etc. with and edge or surface of the main back plate 308 that forms the opening 322, and/or edge or surface of the base catch plate 320. The opening 322 may be located more proximate to the bottom 302 than the top 300 and may be formed via stamping.

The upper plate 310 may include one or more flanges 324, such as a first flange 324(1) and a second flange 324(2) that assist in securing the solar panel module 102 to the first mount 104 and within the receptacle 304. For example, once the solar panel module 102 is engaged within the receptacle 304, in the event that the solar panel module 102 retracts at least partially out of the receptacle 304 (e.g., in the X-direction), the solar panel module 102 may abut the flanges 324. Such contact may prevent the solar panel module 102 disengaging with the first mount 104. A distance 332 may be interposed between the flanges 324 and the receptacle 304 (e.g., an end of the frame catch plate 312). The distance 332 may permit the solar panel module 102 to be slid into the receptacle 304.

The first mount 104 may include one or more engagement mechanism(s) formed along the upper plate 310 and/or the frame catch plate 312. In an embodiment, the engagement mechanisms(s) may include one or more prongs 326 that engage with the solar panel module 102. For example, the prongs 326 may include a first prong 326(1) and a second prong 326(2) on the upper plate 310, and a third prong 326(3) and a fourth prong 326(4) on the frame catch plate 312. When the solar panel module 102 is advanced into the receptacle 304 (e.g., in the X-direction), the prongs 326 may prevent the solar panel module 102 retracting out of the receptacle 304. For example, the prongs 326 may engage with the solar panel module 102 to notch or dig into the solar panel module (e.g., a frame thereof). Moreover, as the solar panel module 102 is advanced into the receptacle 304, the upper plate 310 and the frame catch plate 312 may at least partially deflect, and the deflection may cause the upper plate 310 and/or the frame catch plate 312 to bias the prongs 326 into the solar panel module 102. In an embodiment, the prongs 326 may at least partially score, deform, indent, etc. the frame of the solar panel module 102. The frame catch plate 312 may also include a lip 330 that assists in guiding the solar panel module 102 into the receptacle 304.

The first prong 326(1) and the second prong 326(2) may represent upturned prongs, while the third prong 326(3) and the fourth prong 326(4) may represent downturned prongs. The upturned prongs may be spaced above, or extend above, the upper plate 310, in a direction towards the top 300. The downturned prongs may be spaced below, or extend below, the frame catch plate 312, in a direction towards the bottom 302. As shown, the prongs 326 may extend into the receptacle 304 for engaging with the frame of the solar panel module 102. For example, the first prong 326(1) and the second prong 326(2) may engage with a bottom of the solar panel module 102 (or a frame thereof), while the third prong 326(3) and the fourth prong 326(4) may engage with a top of the solar panel module 102 (or a frame thereof). Although the upper plate 310 and the frame catch plate 312 are shown including two of the prongs 326, respectively, the upper plate 310 and/or the frame catch plate 312 may include more than or less than two of the prongs 326.

In an embodiment, the first prong 326(1) and the second prong 326(2) may be horizontally aligned (e.g., in the Z-direction), and/or the third prong 326(3) and the fourth prong 326(4) may be horizontally aligned (e.g., in the Z-direction). In an embodiment, the first prong 326(1) and the third prong 326(3) may or may not be vertically aligned (e.g., in the X-direction), and/or second prong 326(2) and the fourth prong 326(4) may or may not be vertically aligned (e.g., in the X-direction). In an embodiment, the first prong 326(1), the second prong 326(2), the third prong 326(3), and/or the fourth prong 326(4) may be formed via punching, stamping, etc.

In an embodiment, the bottom 302 of the first mount 104 may include padding 328 to prevent the first mount 104 damaging the surface 112.

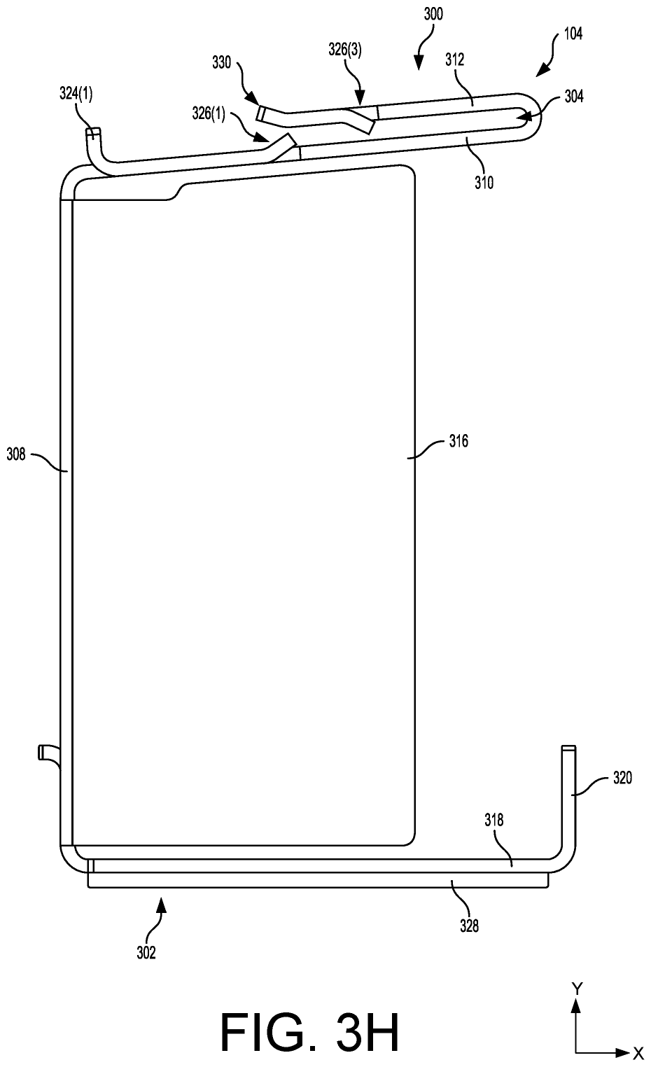

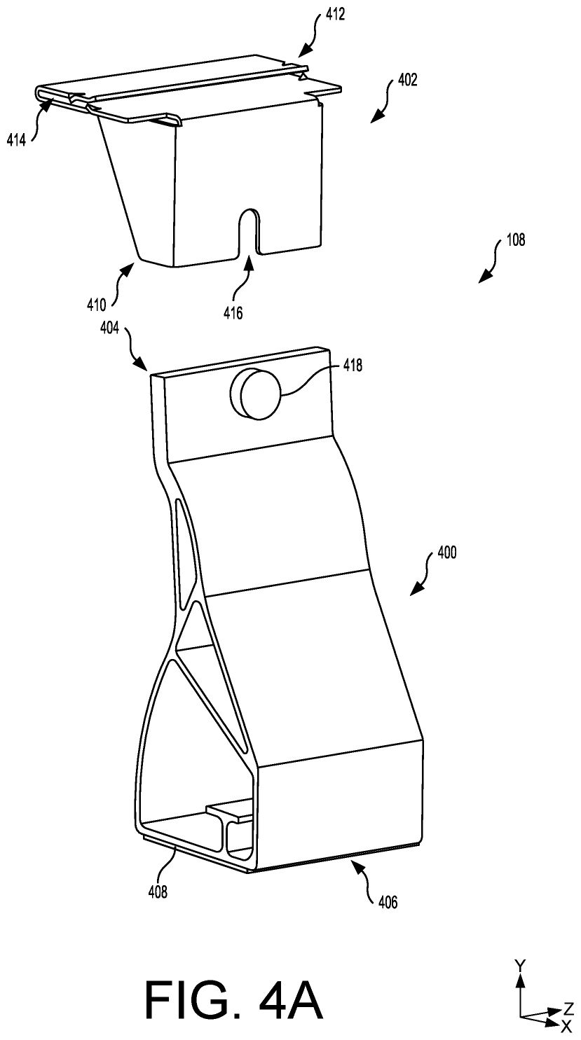

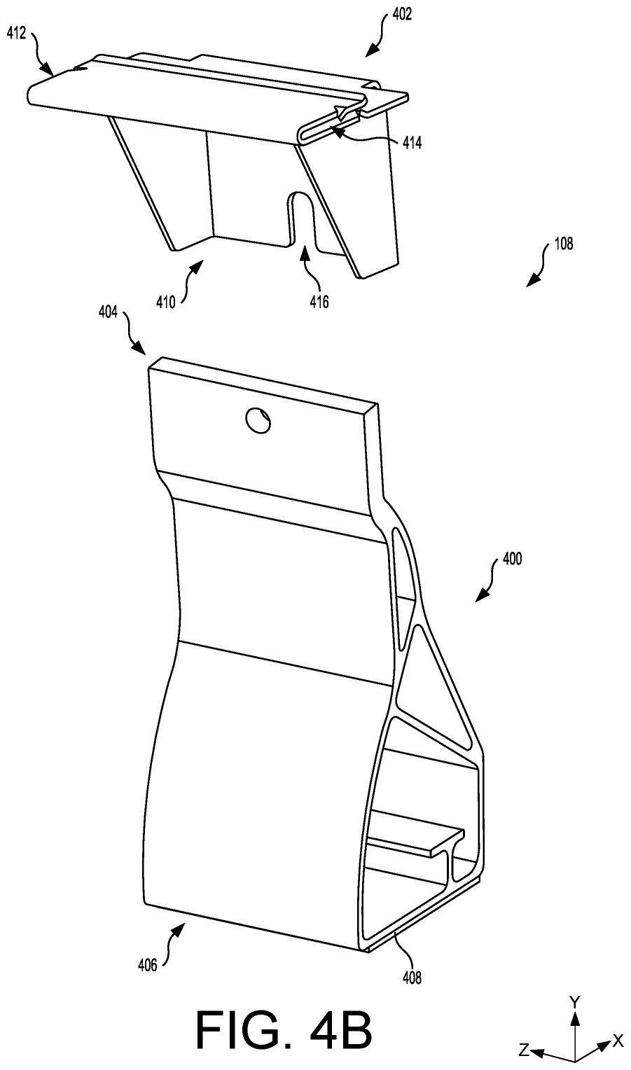

FIGS. 4A and 4B illustrate isometric views of the second mount 108, according to embodiments of the present disclosure. In an embodiment, the second mount 108 may include a lower member 400 (e.g., portion, section, segment, piece, etc.) and an upper member 402 (e.g., portion, section, segment, piece, etc.). The lower member 400 may include a top 404 that engages with, couples to, or receives the upper member 402, and a bottom 406 that couples to the surface 112 (e.g., roof). In an embodiment, the lower member 400 of the second mount 108 may be disposed on the surface 112. In an embodiment, the bottom 406 of the lower member 400 may include padding 408 to prevent damage to the surface 112. In an embodiment, the second mount 108 is designed as two pieces to allow for an avoidance of obstacles of the brackets 204, the solar panel module 102, and/or components coupled thereto (e.g., ballast tray, wind deflector, etc.)

The upper member 402 may include a bottom 410 that couples to the top 404 of the lower member 400. A top 412 of the upper member 402 may include a receptacle 414 that couples to the solar panel module 102. As will be explained herein, the receptacle 414 may be similar to the receptacle 304. The upper member 402 may include a slot 416 that receives a fastener 418 of the lower member 400. For example, to couple the lower member 400 and the upper member 402 together, a body of the fastener 418 may be received within the slot 416, and thereafter, the fastener 418 may be tightened. The slot 416 may include a depth (e.g., in the Y-direction) that slidably engages around a body of the fastener 418 to raise the upper member 402 by different distances from the lower member 400.

As will be explained herein, the lower member 400 may include curvatures, shapes, indents, and features that route around, through, and/or alongside features of the solar panel module 102. For example, the lower member 400 may curve alongside or around ballast trays that are used to secure the solar panel module 102 to the surface 112 and/or wind deflectors coupled to the solar panel module 102, the second mount 108, etc.

In an embodiment, the lower member 400 of the second mount 108 may be formed via extrusion, while the upper member 402 of the second mount 108 may be formed via stamping and bending. Although the system 100 is shown and described as including two different mounts, in an embodiment, the same mount may be used to couple to the solar panel module 102. For example, in an embodiment, the solar panel module 102 may not include ballast trays and/or wind deflectors. Here, although the second mount 108 is described as having multiple members (e.g., two), in an embodiment, the second mount 108 may include more than or less than two members. For example, the second mount 108 may include three members or four members that couple together to support the solar panel module 102. In an embodiment, however, the second mount 108 may be formed from a single member and may be similar to the first mount 104. For example, in applications with solar panel modules 102 that lack wind deflectors and/or ballast trays, the second mount 108 may not need to include separate members. As such, in an embodiment, the second mount 108 may be similar to the first mount 104, however, the second mount 108 may be taller in length to engage with the solar panel module 102. In other instances, a mount may be adjustable in height for engaging with other solar panel modules 102. For example, the mount may be adjustable in height to span a desired length between the solar panel module 102 and the surface 112.

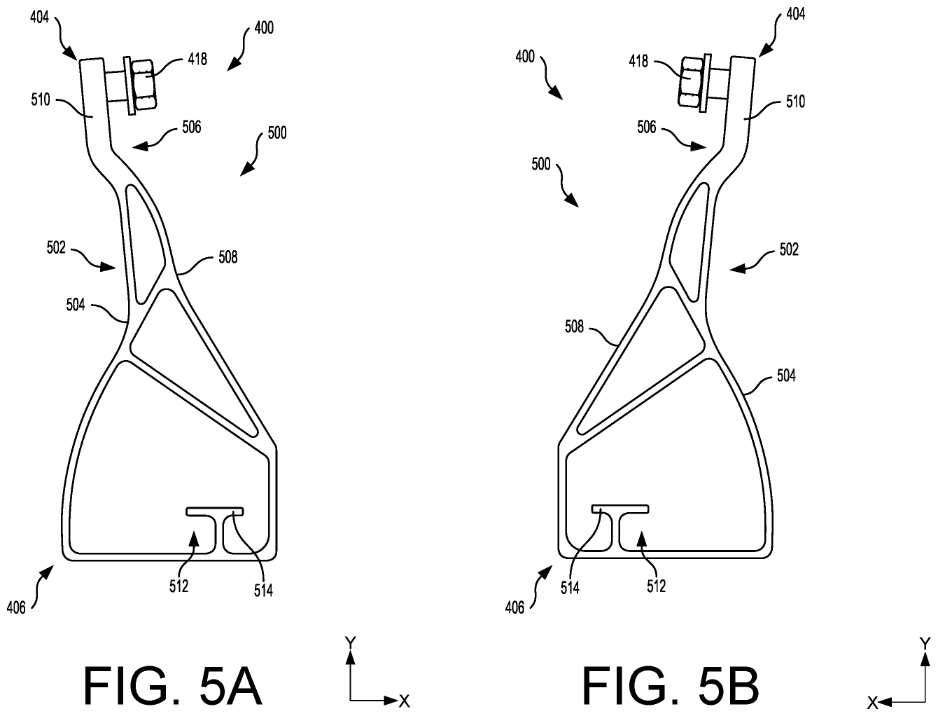

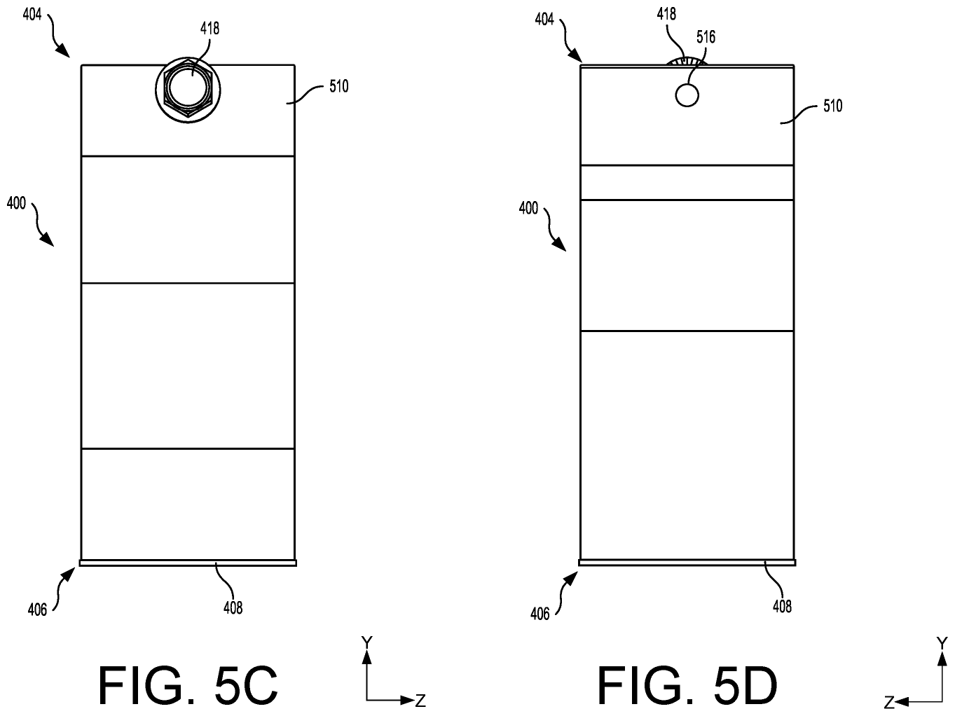

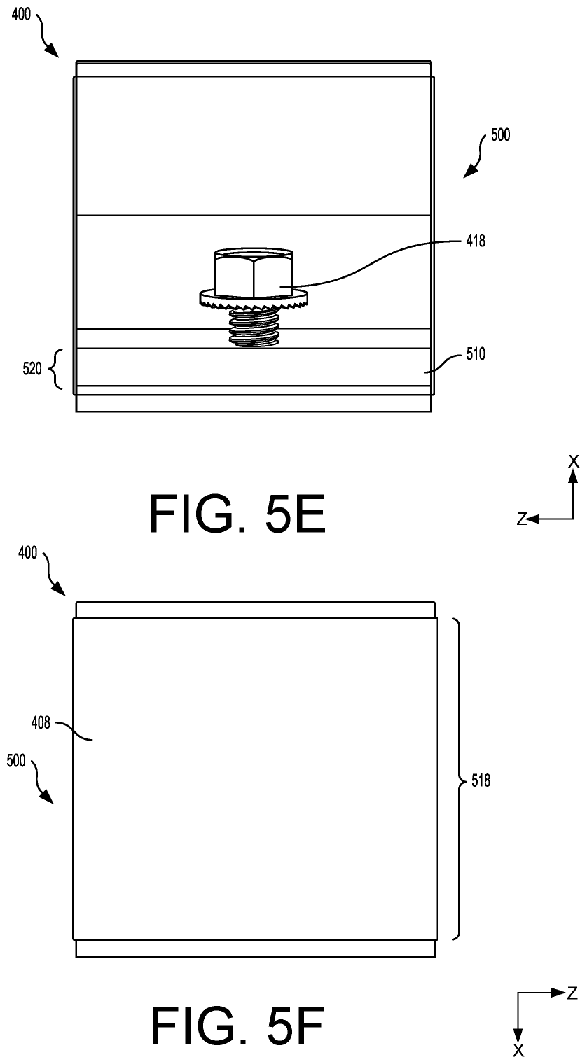

FIGS. 5A-5F illustrate various views of the lower member 400 of the second mount 108, according to embodiments of the present disclosure. The bottom 406 of the lower member 400 may be substantially planar for residing on the surface 112. Between the bottom 406 and the top 404, a body 500 of the lower member 400 may include various curvatures (e.g., in the X-direction). For example, the body 500 of the lower member 400 may include a first indent 502 for accommodating portions of a ballast tray. In other words, the body 500 may curve around portions of the ballast tray to enable the second mount 108 to couple to the solar panel module 102. In an embodiment, when the upper member 402 is uncoupled from the lower member 400, the top 404 of the lower member 400 may route around, through, over, etc. the ballast tray, wind deflector, etc. Thereafter, the upper member 402 may be coupled to the lower member 400 via the fastener 418.

In an embodiment, the first indent 502 is disposed along a first side 504 of the lower member 400. The body 500 may include a second indent 506 disposed along a second side 508 of the lower member 400. The second side 508 may be opposite the first side 504. In an embodiment, the second indent 506 may accommodate a wind deflector that couples to the solar panel module 102 and/or the second mount 108.

In an embodiment, the top 404 of the upper member 402 may include a width that is less than the bottom 406 (e.g., in the X-direction). In doing so, the body 500 may converge at the top 404. In an embodiment, this profile of the body 500 may accommodate a ballast tray, a wind deflector, and/or other components that couple to the solar panel module 102. For example, as shown in FIGS. 5E and 5F, the bottom 406 may have a first width 518 (e.g., in the X-direction), and the top 404 may have a second width 520 (e.g., in the X-direction). The first width 518 may be greater than the second width 520 to provide support to the solar panel module 102, while the second width 520 may be smaller in order to route through, between, and/or around features coupled to the solar panel module 102 (e.g., ballast tray, wind deflector, etc.). The bottom 406 may include the padding 408 to avoid damage to the surface 112.

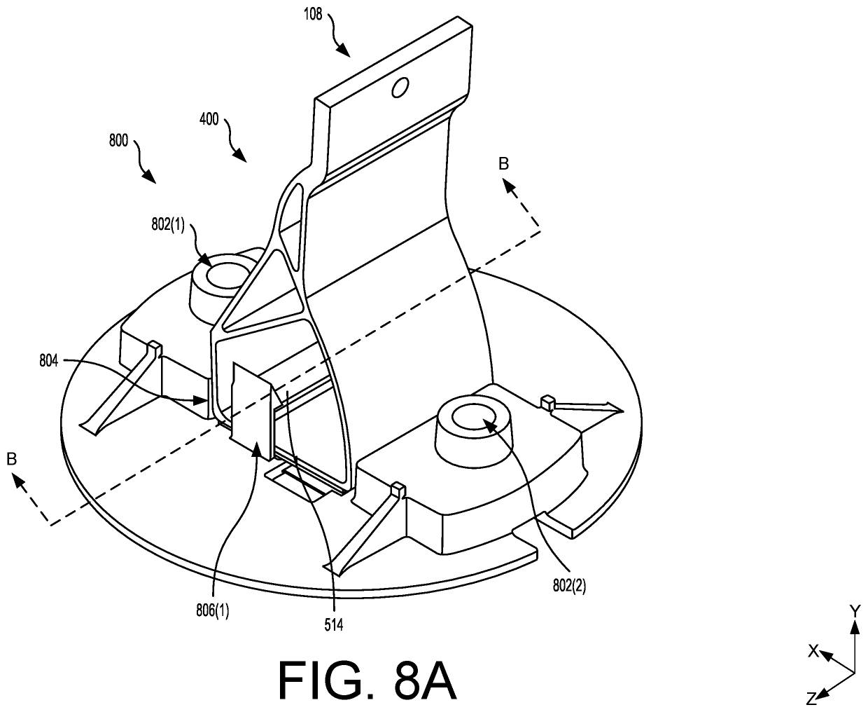

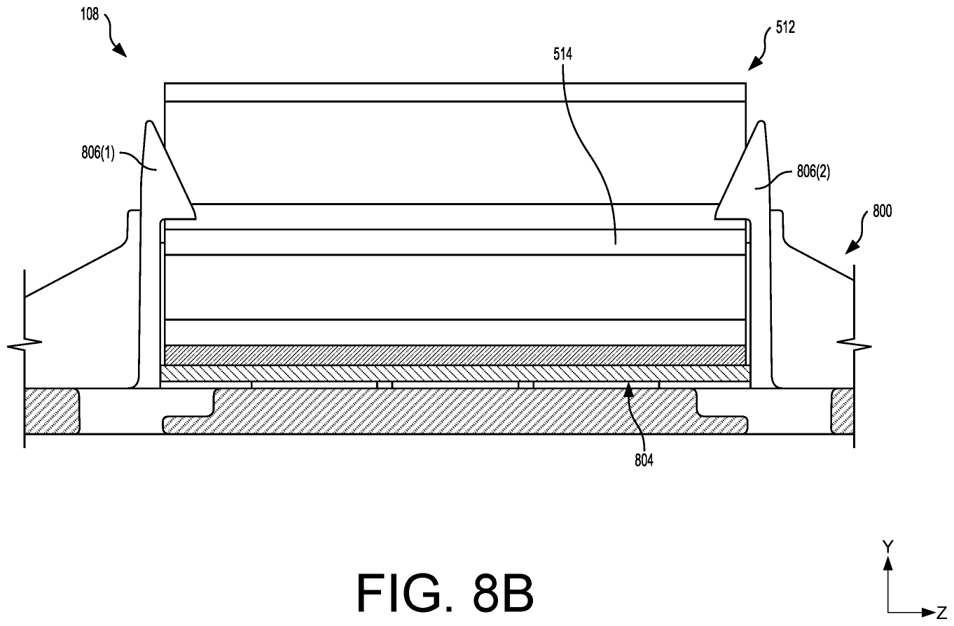

The lower member 400 also includes the fastener 418 for coupling to the upper member 402. In an embodiment, the fastener 418 is disposed on or through a flange 510 located at the top 404. The lower member 400 may define a hole 516 in which the fastener 418 is received. In an embodiment, the lower member 400 of the second mount 108 may couple to a base disposed on the surface 112. In an embodiment, the lower member 400 includes a stem 512 (e.g., projection, foot, base, etc.) having an arm 514 (e.g., ledge, plate, panel, etc.) that engage with features of the base. For example, the base, as will be shown and described in FIGS. 8A and 8B, may include tabs that engage with the arm 514 for coupling the second mount 108 to the base.

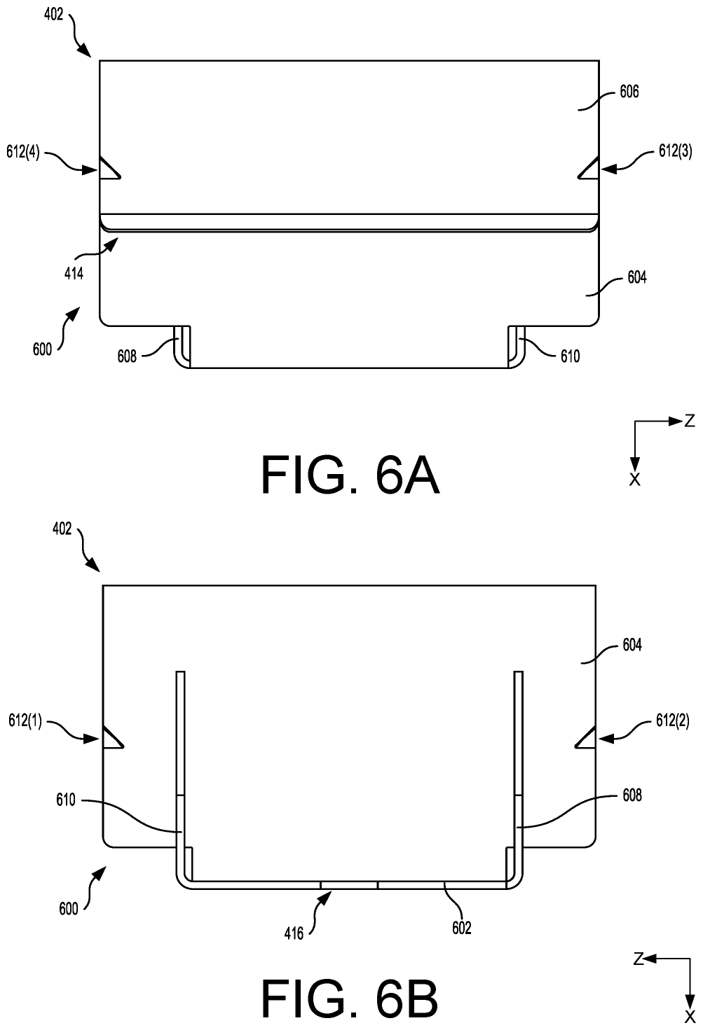

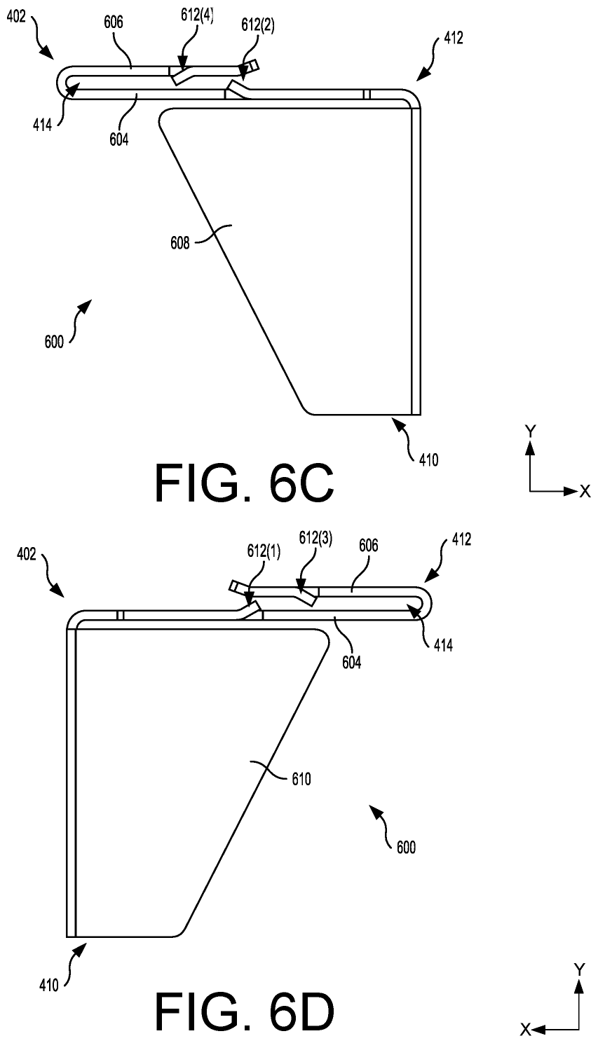

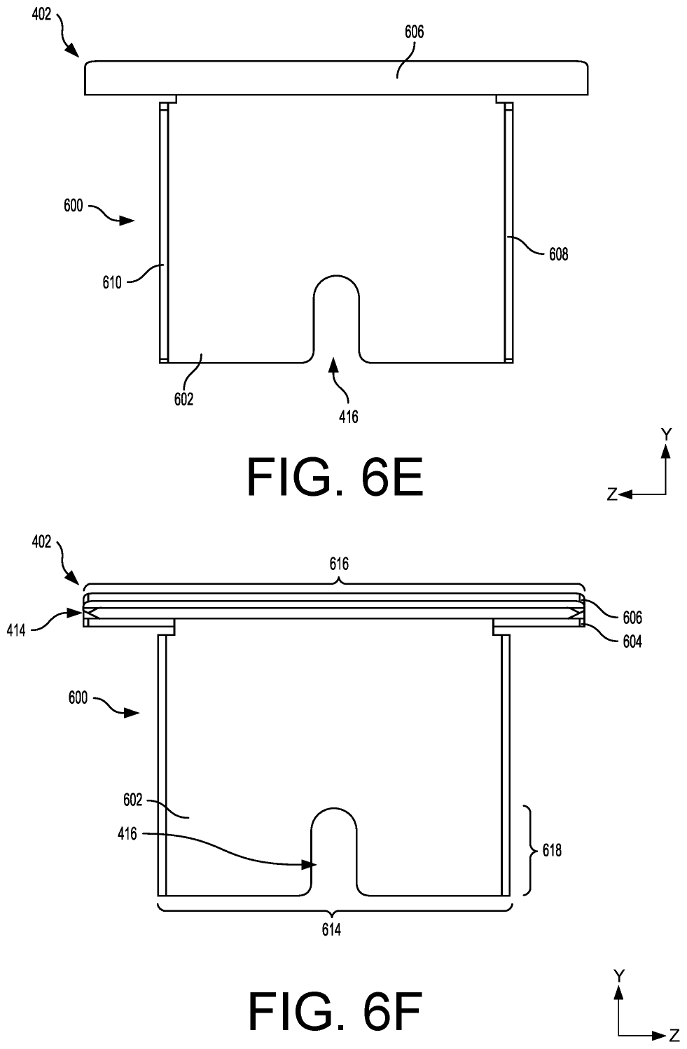

FIGS. 6A-6F illustrate various views of the upper member 402 of the second mount 108, according to examples of the present disclosure. The top 412 of the upper member 402 includes the receptacle 414 that receives the solar panel module 102, or a frame of the solar panel module 120, while the bottom 410 couples to the top 404 of the lower member 400.

In an embodiment, the upper member 402 includes a body 600 that may include many members (e.g., first through fifth members), where a first member is a main back plate 602 from which the other members branch. A second member is an upper plate 604 that folds from or is connected to an end of the main back plate 602. A third member is a frame catch plate 606 that folds (or returns) back from an end of the upper plate 604. A fourth member is a left flange plate 608 that folds from or is connected to a left side of the main back plate 602. A fifth member is a right flange plate 610 that folds from or is connected to a right side of the main back plate 602, opposite from the left flange plate 608. As used herein, a “member” may be an metal strip (e.g., plate, planar segment, section, etc.) integrally joined or formed with other strips, for example. Although described as members, the members may represent sections, segments, portions, panels, etc. of the upper member 402.

In an embodiment, the upper plate 604, the left flange plate 608, and the right flange plate 610 may be adjoined to or extend from the main back plate 602. The frame catch plate 606 may be at least partially disposed over the upper plate 604 to define the receptacle 414. In an embodiment, the frame catch plate 606 may be parallel to the upper plate 604. In an embodiment, the upper plate 604, the left flange plate 608, and/or the right flange plate 610, may extend transverse to the main back plate 602.

In an embodiment, the upper plate 604 and/or the frame catch plate 606 are disposed at least partially over the left flange plate 608 and the right flange plate 610. In an embodiment, the upper plate 604 extends from the main back plate 602 by a greater distance than the left flange plate 608 and/or the right flange plate 610 (e.g., in the X-direction). Moreover, in an embodiment, the left flange plate 608 and/or the right flange plate 610 may include a shorter length (e.g., in the X-direction) proximate to the bottom 410, as compared to the top 412. Accordingly, the left flange plate 608 and/or the right flange plate 610 may extend in a direction away from the main back plate 602, between the bottom 410 and the top 412.

In an embodiment, the upper plate 604 may extend orthogonally from the main back plate 602. The frame catch plate 606 may be orthogonal to the upper plate 604. As shown, the upper plate 604 and the frame catch plate 606 define the receptacle 414 for receiving the solar panel module 102. The left flange plate 608 and/or the right flange plate 610 may be orthogonal to the main back plate 602. When the upper member 402 couples to the lower member 400, the top 412 of the upper member 402 may be oriented between approximately five and forty degrees relative to the bottom 406 of the lower member 400. For example, the upper plate 604 and/or the frame catch plate 606 may be oriented between approximately five degrees and forty degrees relative to the bottom 406. Such angle may be associated with an angle at which the solar panel module 102 is disposed on the surface 112.

The main back plate 602 may define the slot 416 that receives the fastener 418. Upon tightening of the fastener 418, the main back plate 602 may become compressed between the fastener 418 and the lower member 400 of the second mount 108 (e.g., the flange 510).

The upper member 402 may include one or more engagement mechanism(s) formed along the upper plate 604 and/or the frame catch plate 606. In an embodiment, the engagement mechanisms(s) may include one or more prongs 612 that engage with the solar panel module 102. For example, the prongs 612 may include a first prong 612(1) and a second prong 612(2) formed in the upper plate 604, and a third prong 612(3) and a fourth prong 612(4) formed in the frame catch plate 606. In an embodiment, the first prong 612(1), the second prong 612(2), the third prong 612(3), and/or the fourth prong 612(4) may be formed via punching, stamping, etc.

When the solar panel module 102 is advanced into the receptacle 414, the prongs 612 may prevent the solar panel module 102 retracting out of the receptacle 414. For example, the prongs 612 may engage with the solar panel module 102 to notch or dig into the solar panel module 102 (e.g., a frame thereof). Moreover, as the solar panel module 102 is advanced into the receptacle 414, the upper plate 604 and the frame catch plate 606 may at least partially deflect, and the deflection may cause the upper plate 604 and/or the frame catch plate 606 to bias the prongs 612 into the solar panel module 102. In an embodiment, the prongs 612 may at least partially score, deform, indent, etc. the frame of the solar panel module 102. In an embodiment, the upper plate 604 may be similar to the upper plate 310, the frame catch plate 606 may be similar to the frame catch plate 312, and/or the receptacle 414 may be similar to the receptacle 304.

The first prong 612(1) and the second prong 612(2) may represent upturned prongs, while the third prong 612(3) and the fourth prong 612(4) may represent downturned prongs. The upturned prongs may be spaced above the upper plate 604 and extend in a direction towards the top 412. The downturned prongs may be spaced below the frame catch plate 606 and extend in a direction towards the bottom 410. The first prong 612(1) and the second prong 612(2) may engage with a bottom of the solar panel module 102 (or a frame thereof), while the third prong 612(3) and the fourth prong 612(4) may engage with a top of the solar panel module 102 (or a frame thereof). In an embodiment, the first prong 612(1) and the second prong 612(2) may be horizontally aligned (e.g., in the Z-direction), and/or the third prong 612(3) and the fourth prong 612(4) may be horizontally aligned (e.g., in the Z-direction). In an embodiment, the first prong 612(1) and the third prong 612(3) may or may not be vertically aligned (e.g., in the X-direction), and/or second prong 612(2) and the fourth prong 612(4) may or may not be vertically aligned (e.g., in the X-direction). Although the upper plate 604 and the frame catch plate 606 are shown including two of the prongs 612, respectively, the upper plate 604 and/or the frame catch plate 606 may include more than or less than two of the prongs 612.

In an embodiment, the main back plate 602 includes a first width 614 (e.g., in the Z-direction) that is less than a second width 616 (e.g., in the Z-direction) of the upper plate 604 and/or the frame catch plate 606. In an embodiment, the slot 416 maybe centrally located across the first width 614. The slot 416 may also include a depth 618 (e.g., in the Y-direction), and the fastener 418 may be tightened to the upper member 402 at various locations within the depth 618 to adjust a height of the second mount 108 (or a height of the upper member 402 relative to the lower member 400). Such adjustment may accommodate variances in the positioning of the solar panel module 102, and to ensure that the second mount 108 supports the weight of the solar panel module 102 against the surface 112. When the upper member 402 couples to the lower member 400, the top 404 of the lower member 400 may reside between the left flange plate 608 and the right flange plate 610 (e.g., in the Z-direction).

FIGS. 7A and 7B illustrate the first mount 104 coupled to a first base 700, according to embodiments of the present disclosure. FIG. 7B illustrates a cross-sectional view of the first mount 104 and the first base 700, taken along line A-A of FIG. 7A.

The first base 700 may include passages 702 (e.g. channel, port, hole, etc.), such as a first passage 702(1) and a second passage 702(2), for coupling the first base 700 to the surface 112 (e.g., fasteners disposed therethrough). In an embodiment, the first mount 104 is received within a port 704 (e.g., receptacle, depot, etc.) of the first base 700. The first base 700 may include tabs 706, such as a first tab 706(1) and a second tab 706(2), that engage with a surface of the main back plate 308, within the opening 322, and a surface of the base catch plate 320, respectively. For example, the first tab 706(1) may include a hook that engages with a first surface 708 (e.g., ledge, flange, etc.) of the main back plate 308, and the second tab 706(2) may include a hook that engages with a second surface 710 of the base catch plate 320. Such engagement may couple the first mount 104 to the first base 700. In this sense, the first mount 104 may snap into engagement with the first base 700, within the port 704. However, the tabs 706 may deflect to permit the first mount 104 to decouple from the first base 700. For example, the tabs 706 may be biased outward to release the first mount 104 from the first base 700.

Although described in use with the first base 700, in an embodiment, the first mount 104 may be used independently of the first base 700. In such embodiments, the bottom 302 of the first mount 104 may be in direct contact with the surface 112. However, the first base 700 may be used to increase a footprint of the first mount 104 for stabilization.

FIGS. 8A and 8B illustrate the second mount 108 coupled to a second base 800, according to embodiments of the present disclosure. FIG. 8B illustrates a cross-sectional view of the second mount 108 and the second base 800, taken along line B-B of FIG. 8A.

The lower member 400 of the second mount 108 may couple to the second base 800. The second base 800 may include passages 802 (e.g. channel, port, hole, etc.), such as a first passage 802(1) and a second passage 802(2), for coupling the second base 800 to the surface 112 (e.g., fasteners disposed therethrough). In an embodiment, the second mount 108 is received within a port 804 (e.g., receptacle, depot, etc.) of the second base 800. The second base 800 may include tabs 806, such as a first tab 806(1) and a second tab 806(2), that engage with the arm 514 of the stem 512. Such engagement may couple the second mount 108 to the second base 800. For example, the first tab 806(1) may include a hook that engages with the arm 514, or a surface thereof, and the second tab 806(2) may include a hook that engages with the arm 514, or a surface thereof. Such engagement may couple the second mount 108 to the second base 800. In this sense, the second mount 108 may snap into engagement with the second base 800, within the port 804. However, the tab 806 may deflect to permit the second mount 108 to decouple from the second base 800. For example, the tab 806 may be biased outward to release the second mount 108 from the second base 800.

Although described in use with the second base 800, in an embodiment, the second mount 108 may be used independently of the second base 800. In such embodiments, the bottom 406 of the second mount 108 may be in direct contact with the surface 112.

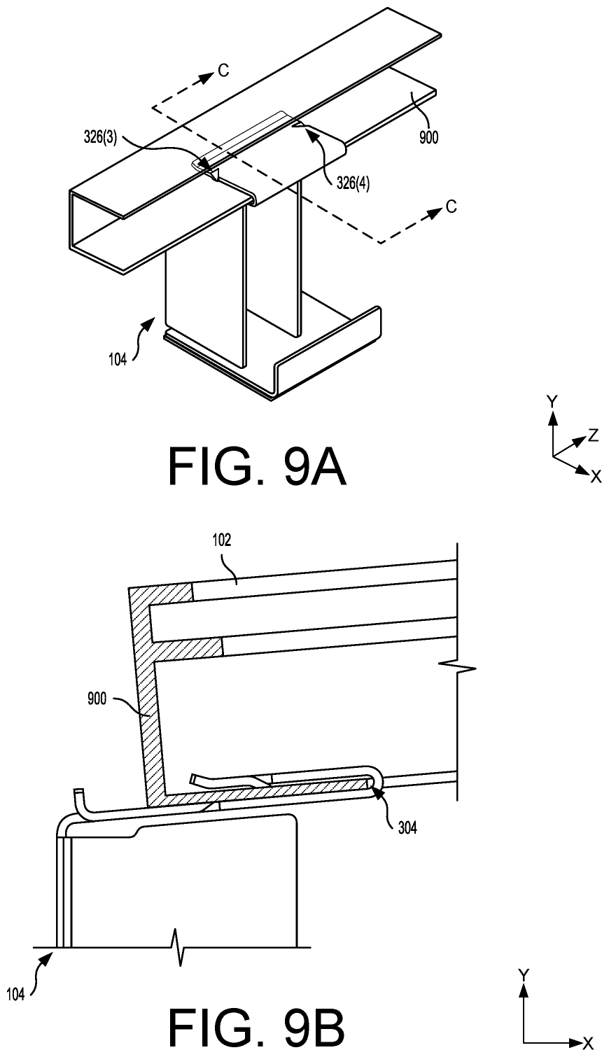

FIGS. 9A and 9B illustrate the first mount 104 coupled to a frame 900 of the solar panel module 102, according to embodiments of the present disclosure. The frame 900 of the solar panel module 102 may be at least partially received within the receptacle 304 of the first mount 104, where the frame 900 may be disposed around the solar panel module 102 and/or provide support to the solar panel module 102. The frame catch plate 312 of the first mount 104 may be disposed on a top side of the frame 900 (or the arm thereof), while the upper plate 310 of the first mount 104 may be disposed on a bottom side of the frame 900 (or the arm thereof). The prongs 326 may additionally engage with the frame 900 to secure the first mount 104 and the frame 900 together.

Although described in use with the solar panel module 102, or the frame 900, the first mount 104 may be used in conjunction with other frames, brackets, rails, and the like.

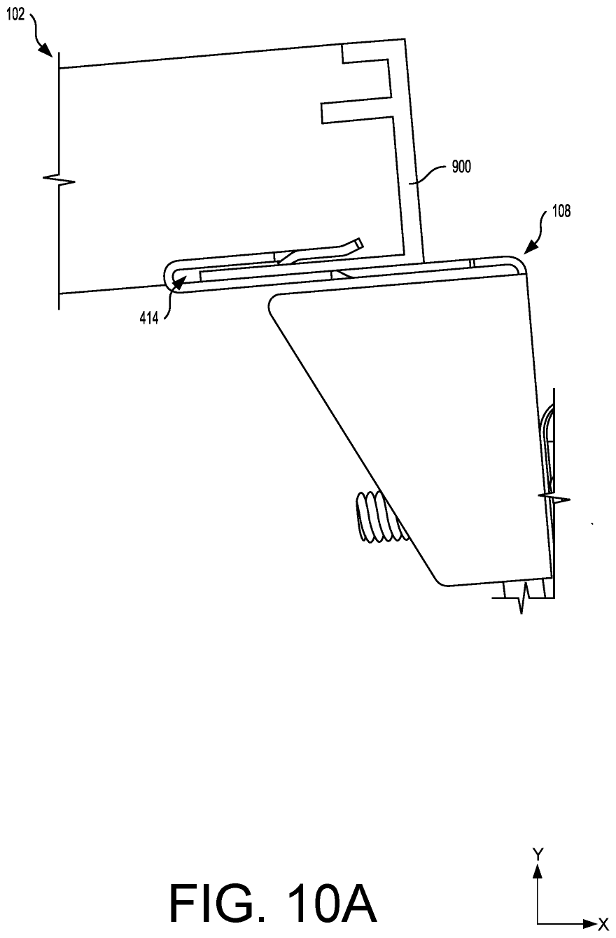

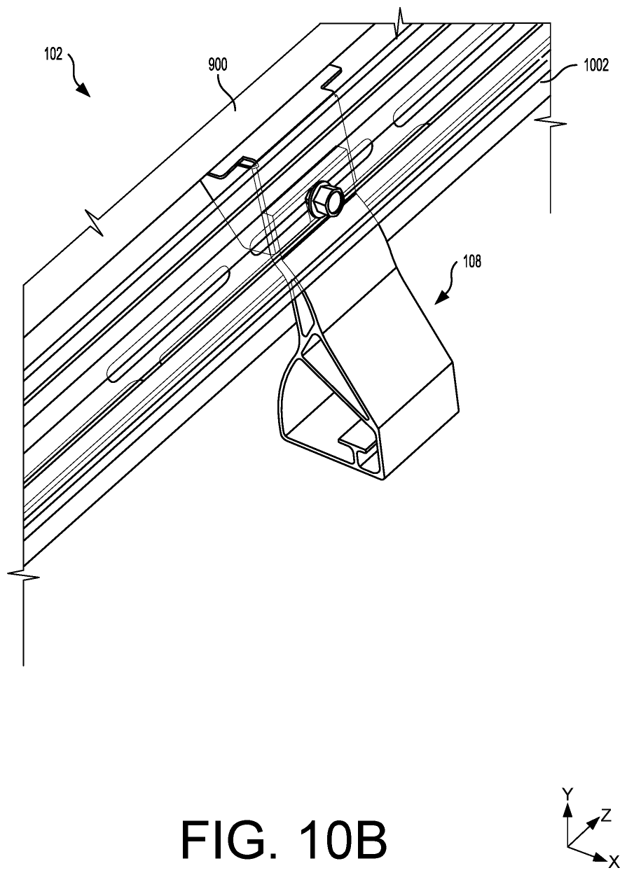

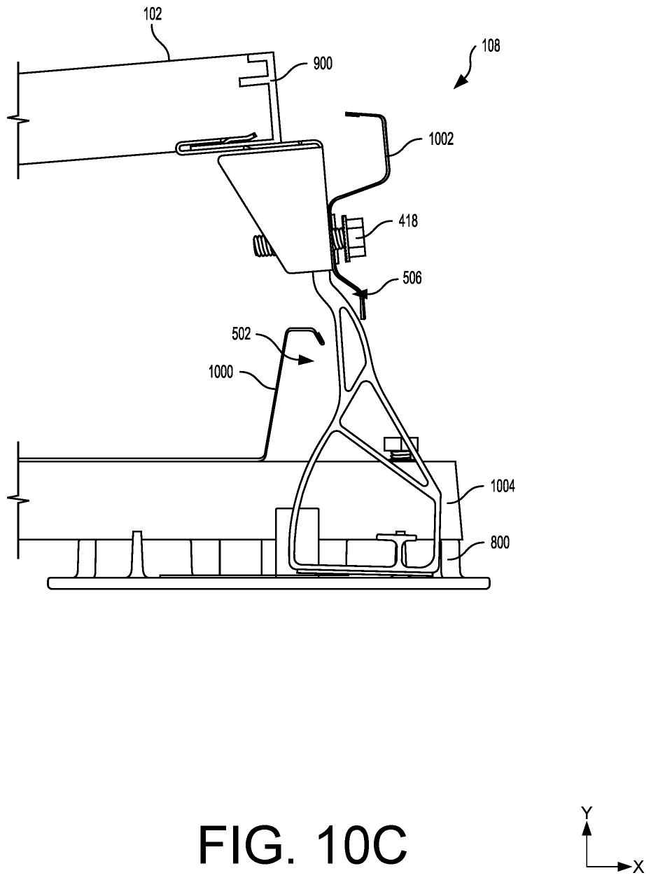

FIGS. 10A-10C illustrate the second mount 108 coupled to the solar panel module 102, according to embodiments of the present disclosure. The frame 900 of the solar panel module 102 may be at least partially received within the receptacle 414 of the second mount 108. Moreover, given the shape of the body 500 of the lower member 400, the second mount 108 may route around, alongside, or through portions of the solar panel module 102 and/or components coupled thereto. For example, as shown in FIG. 10C, the first indent 502 of the lower member 400 may accommodate a ballast tray 1000. Meanwhile, the shape of the top 404 may permit the upper member 402 to be inserted, and coupled to the frame 900, beneath a wind deflector 1002 via the second indent 506. In an embodiment, the wind deflector 1002 couples to the second mount 108 via the fastener 418.

FIG. 10C also illustrates a rail 1004 that may be used to secure the solar panel module 102 to the surface 112. For example, the brackets 204 may be disposed along the rail 1004, or separate rails. In an embodiment, the rail 1004 may couple to the first base 700 and/or the second base 800. The ballast tray 1000 may rest on the rail 1004. In an embodiment, the second mount 108 may be coupled to the solar panel module 102 after installation of the solar panel module 102. In such instances, the shape of the lower member 400 and/or the upper member 402 permits the second mount 108 to be negotiated through the already installed ballast tray 1000 and/or wind deflector 1002. In other instances, the shape of the lower member 400 and/or the upper member 402 permits the second mount 108 to not interfere with the ballast tray 1000 and/or the wind deflector 1002.

While the foregoing invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative of some embodiments that fall within the scope of the claims of the application.

What is claimed is:

1. A mounting system for a solar panel module, comprising:
a first mount including:
a top having a first receptacle to receive a first side of a solar panel module, and
a bottom to reside on a surface; and
a second mount including:
a lower member having:
a top, and
a bottom to reside on the surface, and upper member having:
a top including a second receptacle to receive a second side of the solar panel module opposite the first side of the solar panel module, and
a bottom coupled to the top of the lower member.

2. The mounting system of claim 1, wherein:
the top of the lower member includes a hole; and
the mounting system further comprises a fastener threaded into the hole, the fastener being configured to couple the lower member and the upper member together.

3. The mounting system of claim 2, wherein the upper member includes a slot through which the fastener is at least partially disposed.

4. The mounting system of claim 1, wherein:
the first mount includes one or more first prongs that engage with the first side of the solar panel module; and
the second mount includes one or more second prongs that engage with the second side of the solar panel module.

5. The mounting system of claim 1, further comprising a wind deflector coupled to the second mount.

6. The mounting system of claim 1, wherein the first mount further includes:
a main back plate;
an upper plate extending transverse to the main back plate;
a frame catch plate extending substantially parallel to the upper plate;
a left flange plate extending transverse to the main back plate;
a right flange plate extending transverse to the main back plate;
a lower support plate extending transverse to the main back plate; and
a base catch plate extending transverse to the lower support plate.

7. The mounting system of claim 6, wherein the upper plate and the frame catch plate at least partially form the first receptacle.

8. The mounting system of claim 1, wherein the upper member includes:
a main back plate;
an upper plate extending transverse to the main back plate;
a frame catch plate extending substantially parallel to the upper plate;
a left flange plate extending transverse to the main back plate; and
a right flange plate extending transverse to the main back plate.

9. The mounting system of claim 8, wherein the upper plate and the frame catch plate form the second receptacle.

10. A mounting system for a solar panel module, comprising:
a first mount for supporting a solar panel module a first distance above a surface, the first mount including:
a receptacle to receive a first side of the solar panel module, and
one or more prongs to engage the solar panel module along the first side; and
a second mount for supporting the solar panel module a second distance above the surface, the second distance being greater than the first distance, the second mount including:
a receptacle to receive a second side of the solar panel module, opposite the first side of the solar panel module, and
one or more prongs to engage the solar panel module along the second side.

11. The mounting system of claim 10, wherein:
the first mount is located along the first side, between a first bracket and a second bracket that support the solar panel module to the surface; and
the second mount is located along the second side, between a third bracket and a fourth bracket that support the solar panel module to the surface.

12. The mounting system of claim 10, wherein the second mount includes a lower member and an upper member removably coupled to the lower member, the upper member including the receptacle of the second mount.

13. The mounting system of claim 10, further comprising at least one of:
a first base coupled to the first mount, the first base to reside on the surface; and
a second base coupled to the second mount, the second base to reside on the surface.

14. The mounting system of claim 13, wherein:
the first mount includes:
a main back plate having a channel,
a lower support plate extending from the main back plate, and
a base catch plate extending from the lower support plate;
the second mount includes a stem having an arm;
the first base includes:
a first tab that engages with the main back plate at a location within the channel, and
a second tab that engages with the base catch plate; and
the second base includes one or more tabs that engage with the arm.

15. The mounting system of claim 10, wherein the first mount and a second mount transfer a load of the solar panel module to the surface.

16. The mounting system of claim 10, wherein the second mount includes an indent, disposed between a bottom of the second mount and a top of the second mount, to accommodate a ballast tray that supports the solar panel module.

17. A system comprising:
a first mount supporting a first side of a solar panel module, the first mount including a receptacle in which at least a first portion of a frame of the solar panel module is disposed; and
a second mount spaced apart from the first mount and supporting a second side of the solar panel module opposite the first side, the second mount including:
a lower member, and
a upper member removable coupled to the lower member, the upper member having a receptacle in which at least a second portion of the frame of the solar panel module is disposed.

18. The system of claim 17, wherein:
the first mount supports the solar panel module at a first height above a surface; and
the second mount supports the solar panel module at a second height above the surface, the second height being greater than the first height.

19. The system of claim 17, wherein:
the first mount is located along the first side, between a first bracket and a second bracket that support the solar panel module; and
the second mount is located along the second side, between a third bracket and a fourth bracket that support the solar panel module.

20. The system of claim 17, wherein:
the first mount includes one or more first prongs to engage the first portion of the frame of the solar panel module at a location within the receptacle of the first mount; and
the second mount includes one or more second prongs to engage the second portion of the frame of the solar panel module at a location within the receptacle of the second mount.
